(19) United States
(12) Patent Application Publication
(10) Pub. No.: US 2009/0083470 A1
(43) Pub. Date: Mar. 26, 2009

(54) SYSTEM ON CHIP DEVICE AND METHOD FOR MULTIPLE DEVICE ACCESS THROUGH A SHARED INTERFACE

(75) Inventor: Rui Yang, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ALI CORPORATION, Taipei (TW)

(21) Appl. No.: 11/859,823

(22) Filed: Sep. 24, 2007

(51) Int. Cl. G06F 13/20

(52) U.S. Cl. 710/313

(57) ABSTRACT

A system on chip device for communicating with a plurality of external devices is provided. The system on chip device comprises a plurality of host controllers, a shared interface and an arbiter. The plurality of host controllers with a plurality of protocols configures and drives the plurality of external devices. The shared interface coupled between the plurality of host controllers and the plurality of external devices comprise a plurality of data lines and plural sets of control lines, wherein the plurality of data lines are shared by the plurality of host controllers and the plural set of control lines are separately coupled to the plurality of host controllers. The arbiter is coupled to the plurality of host controllers for receiving a plurality of requests and granting one of the plurality of host controllers access to the corresponding external device through the shared interface in accordance with a priority scheme.

### BACKGROUND OF THE INVENTION

1. Field of the Invention

The invention generally relates to system on chip (SOC) designs, and, more particularly, the invention relates to a system on chip device for multiple device access through a shared interface.

2. Description of the Related Art

As system on chip devices become increasingly popular, reducing the total number of pins has become a critical issue. When a system on chip device communicates with various external devices at the same time, the system on chip device requires separate interfaces. Unfortunately, pin count of the system on chip device is accordingly increased.

One proposed solution to the foregoing problem involves sharing the peripheral device bus. However, only external devices with similar protocols, such as an ATA device and a FLASH device, may share the bus. In addition, access of different external devices is accomplished in separate time frames, that is, software is unable to access different external devices at the same time. For example, a FLASH device is unable to be accessed when a DMA transfer from an ATA device is active. Consequently, it is necessary for the software or processor of the system on chip device to detect and manage sharing, which causes failure of real time processing.

Alternately, for other conventional pin sharing techniques, a system on chip device shares the peripheral device bus by a combined host interface controller. Thus, the total number of output pins can be reduced. However, since the access of different external devices is accomplished in separate time frames, software is not allowed to access different external devices simultaneously. Therefore, a significant amount of management is required by software to avoid conflict during interface sharing. Further, the use of the dedicated host controller has disadvantages of higher cost and lower flexibility.

Thus, there is a need for a system on chip device that is capable of supporting multiple devices and protocols simultaneously through a shared interface with high speed, sharing flexible and no software limitations.

### BRIEF SUMMARY OF THE INVENTION

It is an object of the invention to provide a system on chip device capable of accessing multiple devices through a shared interface.

To obtain the above objective, in a first aspect of the invention, a system on chip device is provided for communicating with a plurality of external devices comprising a plurality of host controllers, a shared interface and an arbiter. The plurality of host controllers with a plurality of protocols configures and drives the plurality of external devices. The shared interface coupled between the plurality of host controllers and the plurality of external devices comprise a plurality of data lines and plural sets of control lines, wherein the plurality of data lines are shared by the plurality of host controllers and the plural set of control lines are separately coupled to the plurality of host controllers. The arbiter couples the plurality of host controllers for receiving a plurality of requests and granting one of the plurality of host controllers to access the corresponding external device through the shared interface in accordance with a priority scheme.

In a second aspect of the invention, a method is provided for multiple device access between a plurality of host controllers in a system on chip device and a plurality of external devices through a shared interface comprising a plurality of data lines and plural sets of control lines, wherein the plurality of host controllers comprise a plurality of protocols to configure and drive the plurality of external devices. First, a first request is received from a set of control lines corresponding to a first protocol. Next, it is decided whether the first request is to be granted in accordance with a priority scheme. Afterwards, the data line transmission is suspended corresponding to a second protocol when the first request is granted. Finally, the data line transmission corresponding to the first request is allowed.

Further, the data lines are shared by the plurality of host controllers and the plural set of control lines are separately controlled by the plurality of host controllers.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram for illustrating a system on chip device in accordance with one embodiment of the invention;

FIG. 2 is a diagram that illustrates an exemplary example of data line transmissions of the shared interface shown in FIG. 1; and

FIG. 3 is a flow diagram for illustrating a method for multiple device access through a shared interface in accordance with another embodiment of the invention.

### DETAILED DESCRIPTION OF THE INVENTION

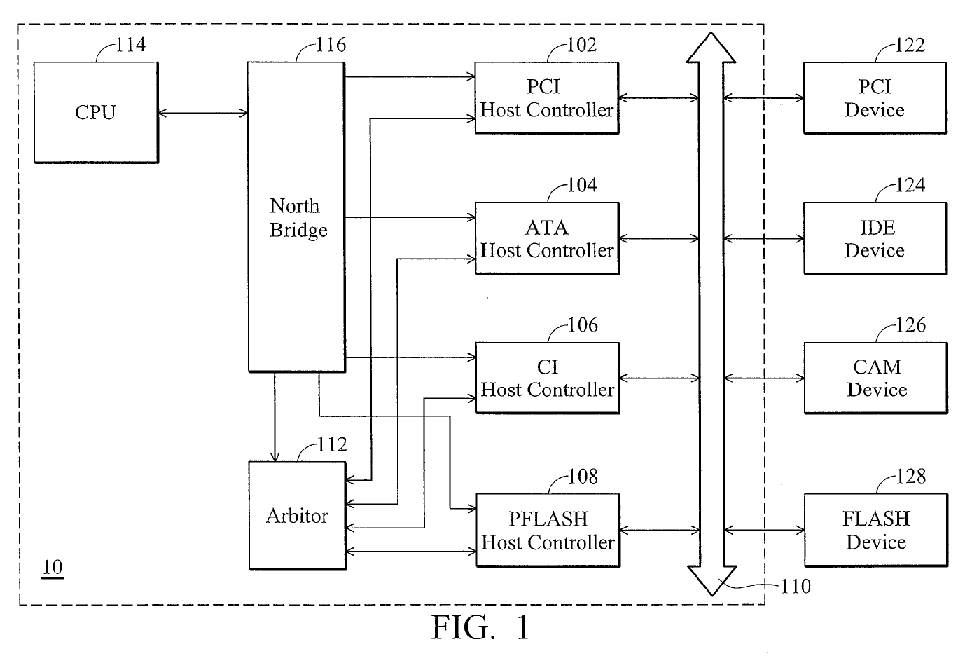

The following exemplary embodiments of the invention are described with reference to FIGS. 1 through 3, which relate to an image processing apparatus and method. It is to be understood that the following disclosure provides various different embodiments as examples for implementing different features of the invention. Specific examples of components and arrangements are described in the following to simplify the present disclosure. These are, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

The invention relates to a system on chip device and method, which is capable of communicating with a plurality of external devices through a shared interface controlled by an arbiter.

FIG. 1 is a block diagram for illustrating a system on chip device 10 in accordance with one embodiment of the invention. The system on chip device 10 may comprise a PCI host controller 102, an ATA host controller 104, a PCMCIA host controller 106, a PFLASH (parallel FLASH) host controller 108, a shared interface 110, an arbiter 112, a central processing unit (CPU) 114 and a north bridge 116, for example, but not limited thereto.

As shown in FIG. 1, all of the host controllers are interfaced with a set of external devices, such as a PCI device 122, an IDE device 124, a CAM device 126 and a FLASH device 128, through the shared interface 110. Therefore, the host controllers 102, 104, 106 and 108 configure and drive the operation of the external devices 122, 124, 126 and 128, respectively. The CPU 114 may be any type of CPU capable of running the operating system software and providing system management. Also, the CPU 114 sends or receives data to/from the set of external devices through the plurality of host controllers. Note that the system on chip device 10 may have one or more CPUs to separately communicate with the host controllers. The north bridge 116 interfaces the CPU 104, the arbiter 112 and the host controllers 102, 104, 106 and 108 for accepting memory requests therefrom and controlling the memory operation of the system on chip device 10. The arbiter 112 is coupled to the host controllers 102, 104, 106 and 108 for receiving and processing requests therefrom.

In the illustrated embodiment, the shared interface 110, respectively interfaces the host controllers 102, 104, 106 and 108 and the external devices 122, 124, 126 and 128. The shared interface 110 comprises a plurality of data lines and plural sets of control lines (not shown). All host controllers share data lines with each other. The plural set of control lines are separated and coupled to the external devices.

During operation, one or more host controller requests for the shared interface 110 will be sent to the arbiter 112. Once the requests are received, the arbiter 112 will employ a priority-scheme to arbitrate among the requests and grant any given host controller, such as the ATA host controller 104, with an enable signal to access the corresponding IDE device 124. When a request from a host controller with higher-priority is granted, the arbiter 112 will suspend data line transmission previously accessed by another host controller with lower priority.

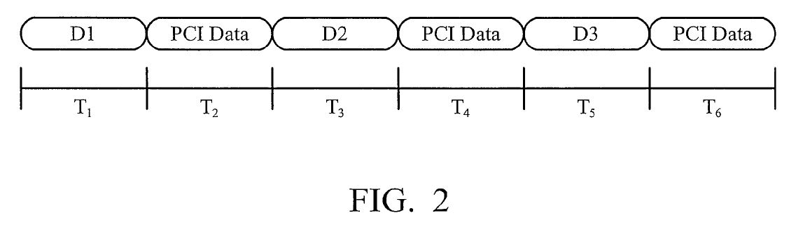

FIG. 2 is a diagram that illustrates an exemplary example of data line transmissions of the shared interface shown in FIG. 1. As shown in FIG. 2, assume that the ATA host controller 104 initializes a DMA transfer when the PCI host controller 102 accesses the PCI device 122 through the data lines of the shared interface. Afterwards, the ATA host controller 104 splits the DMA transfer into three separated DMA operations represented as D1, D2 and D3 according to the ATA protocol. The PCI host controller 102 then stops to access the PCI device 122 and the data line transmission accordingly is suspended. Therefore, the DMA operations D1, D2 and D3 are transmitted during the period T1, T3 and T5, respectively. Further, the PCI host controller 102 is capable of proceeding with transmissions during the time interval between separated DMA operations, such as period T2, T4 and T6. Note that it is unnecessary for both the host controllers and the external devices to be re-initialized when data line transmission access is switched.

Moreover, when a second DMA transfer is initialized by another TDE device (not shown) coupled to the ATA host controller 104 or other host controllers, the arbiter 112 then configures the first and second DMA transfers by setting enable and stop signals to the related host controllers based on the time frame. The first and second DMA transfers are allowed to transmit by alternating when a rotate mode is enabled. Also, the arbiter 112 allows the two DMA transfers to transmit sequentially when the rotate mode is disabled.

As can be appreciated by those skilled in the art, a variety of different host controllers may be used to embody the invention.

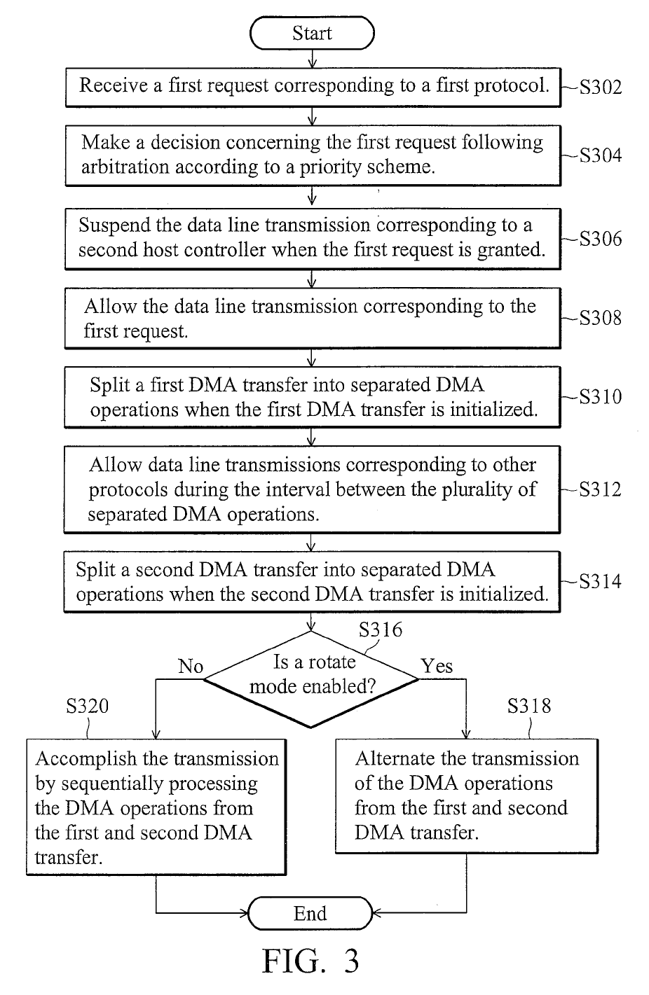

FIG. 3 is a flow diagram for illustrating a method for multiple device access through a shared interface in accordance with another embodiment of the invention. The shared interface communicates between a system on chip device and a plurality of external devices. Further, the shared interface includes a plurality of data lines and plural sets of control lines. The external devices share the data lines but the plural set of control lines are separately controlled by a plurality of protocols, such as a PCI protocol, an ATA protocol or a PCMCIA protocol.

Referring to FIG. 3, a first request is received from a set of control lines corresponding to a first protocol (step S302). Next, a decision is made concerning the first request following arbitration, to determine whether the first request is to be granted according to a priority scheme (step S304). When the first request is granted, the data line transmission corresponding to a second host controller is suspended (step S306). Then, the data line transmission corresponding to the first request is allowed (step S308).

Further, when a first DMA transfer is initialized, the first DMA transfer is split into a plurality of separated DMA operations based on the corresponding protocol (step S310). The data line transmissions corresponding to other protocols are allowed during the interval between the plurality of separated DMA operations (step S312).

Still further, when a second DMA transfer is initialized, the second DMA transfer is split into a plurality of separated DMA operations based on the corresponding protocol (step S314). Before the transmission, a rotate mode is determined (step S316). Next, when the rotate mode is enabled, the transmission of the plurality of separated DMA operations from the first and second DMA transfer alternates (step S318). When the rotate mode is disabled, the transmission is accomplished by sequentially processing the plurality of separated DMA operations from the first and second DMA transfer (step S320).

From the above mentioned, host controllers with different protocols, such as an ATA or a PCI protocol, are able to access a shared interface at the same time. The use of the arbiter, in part, allows a more dynamic, efficient and flexible access of the shared interfaces. Consequently, the described embodiments of the invention allow a substantial reduction in pin count of the system on chip device.

While the invention has been described by way of example and in terms of preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system on chip device for communicating with a plurality of external devices, comprising:
a plurality of host controllers having a plurality of protocols to configure and drive the plurality of external devices;
a shared interface coupled between the plurality of host controllers and the plurality of external devices comprising a plurality of data lines and plural sets of control lines, wherein the plurality of data lines are shared by the plurality of host controllers and the plural set of control lines are separately coupled to the plurality of host controllers; and
an arbiter coupled the plurality of host controllers for receiving a plurality of requests and granting one of the plurality of host controllers to access the corresponding external device through the shared interface in accordance with a priority scheme.

2. The device as claimed in claimed 1, wherein the arbiter grants access to a corresponding external device to one of the host controllers with higher priority and suspends the data line transmission previously accessed by the other of the host controllers with lower priority.

3. The device as claimed in claimed 1, wherein when a first host controller of the plurality of host controllers with a first protocol initializes a first DMA transfer and splits the first DMA transfer into a plurality of separated DMA operations according to the first protocol, the data line transmission of other host controllers are transmitted during the interval between the plurality of separated DMA operations.

4. The device as claimed in claimed 1, wherein when a second DMA transfer is initialized by one of the host controllers, the arbiter configures the first and second DMA transfers to be processed sequentially or in a rotate mode.

5. The device as claimed in claim 1, wherein the plurality of protocols comprises a PCI protocol, an ATA protocol or a PCMCIA protocol.

6. A method for multiple device access between a plurality of host controllers in a system on chip device and a plurality of external devices through a shared interface comprising a plurality of data lines and plural sets of control lines, wherein the plurality of host controllers comprise a plurality of protocols to configure and drive the plurality of external devices, the method comprising:
receiving a first request from a set of control lines corresponding to a first protocol;
deciding whether the first request is to be granted according to a priority scheme following arbitration;
suspending the data line transmission corresponding to a second host controller when the first request is granted; and
allowing the data line transmission corresponding to the first request;
wherein the data lines are shared by the plurality of host controllers and the plural set of control lines are separately controlled by the plurality of host controllers.

7. The method as claimed in claim 6, further comprising:
determining whether a first DMA transfer is initialized;
splitting the first DMA transfer into a plurality of separated DMA operations based on a corresponding protocol; and
allowing data line transmissions corresponding to other protocols during the time interval between the plurality of separated DMA operations.

8. The method as claimed in claim 7, further comprising:
determining whether a second DMA transfer is initialized;
splitting the second DMA transfer into a plurality of separated DMA operations based on the corresponding protocol;
determining whether a rotate mode is enabled or disabled;
conducting the transmission of the plurality of separated DMA operations from the first and second DMA transfer by alternating, when the rotate mode is enabled; and
sequentially processing the plurality of separated DMA operations from the first and second DMA transfer when the rotate mode is disabled.

9. The method as claimed in claim 6, wherein the first protocol and the second protocol comprise a PCI protocol, an ATA protocol or a PCMCIA protocol.
